(19) United States
(12) Patent Application Publication
(10) Pub. No.: US 2018/0119849 A1
(43) Pub. Date: May 3, 2018

(54) FIBRE-REINFORCED HOLLOW BODY FOR CHANNELLING MEDIA, IN PARTICULAR, CHEMICALLY AND/OR MECHANICALLY AGGRESSIVE MEDIA

(71) Applicants: Andreas GRIMM, Wirges (DE); Albert HEMBSCH, Terrades (ES); Ralf TROSCHITZ, Düsseldorf (DE)

(72) Inventors: Andreas GRIMM, Wirges (DE); Albert HEMBSCH, Terrades (ES); Ralf TROSCHITZ, Düsseldorf (DE)

(73) Assignee: STEULER KORROSIONSSCHUTZ HOLDING GMBH, Siershahn (DE)

(21) Appl. No.: 15/567,026

(22) PCT Filed: Apr. 13, 2016
(86) PCT No.: PCT/DE2016/100174

§ 371 Date: Oct. 16, 2017

(30) Foreign Application Priority Data
Apr. 16, 2015 (DE) 10 2015 105 829.4

(51) Int. Cl. F16L 9/12; F16L 9/133; F16L 57/06

(52) U.S. Cl. CPC F16L 9/121; F16L 57/06; F16L 9/133

(57) ABSTRACT

The invention relates to a fibre-reinforced hollow body (10) for channelling media, in particular, chemically and/or mechanically aggressive media, for example, of the chemical industry and/or the process industry, having a base body (20), comprising a material containing fibres, and having a protective layer (40) for protecting the hollow body (10) against chemical and/or mechanical attacks. The protective layer (40) is formed from a fibre-free material or a substantially fibre-free material. The invention relates to a chemical composition for forming a protective layer (40) of a hollow body (10) for channelling media, in particular chemically and/or mechanically aggressive media, said protective layer protecting against chemical and/or mechanical attacks. Furthermore, the invention relates to method for producing a hollow body (10) for channelling media, in particular chemically and/or mechanically aggressive media, for example, of the chemical industry and/or the process industry.

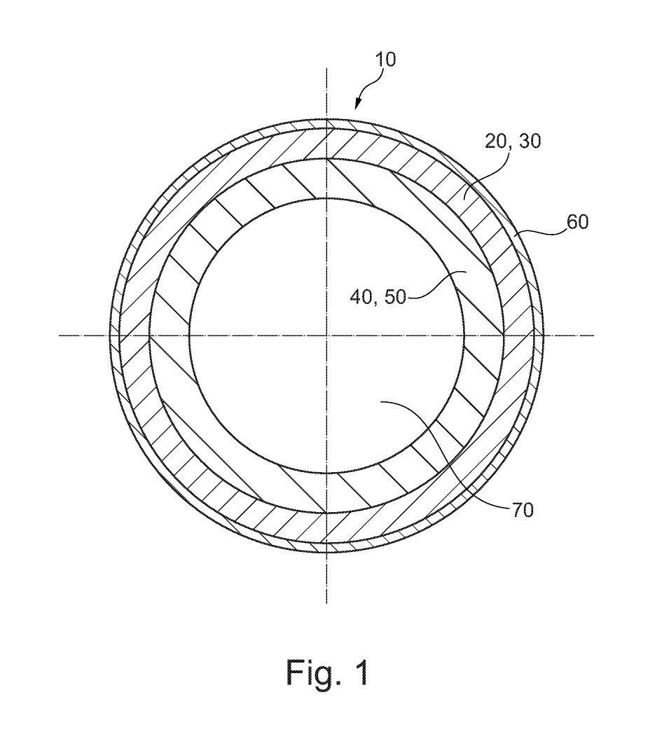

The invention relates to a fibre-reinforced hollow body for channelling media, in particular, chemically and/or mechanically aggressive media, for example, of the chemical industry and/or the process industry.

Such hollow bodies are, for example, fibre-reinforced plastic pipes. The plastic pipes comprise a protective layer on the inner circumference thereof. The protective layer protects said plastic pipes against chemical and/or mechanical attacks of the medium flowing through. Said protective layer, also referred to as a chemical-protective layer, is usually formed from a resin-rich material, in which glass fibres are embedded, for example, in order to prevent brittleness of the protective layer. The fibres are usually a component of textile glass mats and/or nonwoven fabrics, which are embedded in the resin-rich material in the protective layer.

Practice has shown that depending on the application purpose of the fibre-reinforced plastic pipes, the flowing media can be so aggressive that signs of wear appear prematurely on the protective layer of the plastic pipes. For example, the resin-rich material of the protective layer is worn away faster than expected by the channelled media to the extent that the textile glass mat and nonwoven fabrics become exposed and parts thereof are carried away by the flow of media. This leads, firstly, to a premature failure of the plastic pipe per se. Secondly, defects ensue prematurely to systems in which the plastic pipes are used, since the parts of the glass mats and nonwoven fabrics which are carried away clog filters, screens or even the pipes themselves.

The problem of the invention is thus to propose at least one possibility of providing a fibre-reinforced hollow body of the aforementioned type through which the premature occurrence of said signs of wear is avoided.

This problem is solved by a fibre-reinforced hollow body which has the features of claim 1. In order to solve this problem, a chemical composition is proposed to form a protective layer of a hollow body comprising the features of claim 34, said protective layer protecting against chemical and/or mechanical attacks. Furthermore, in order to solve the problem, a method is proposed for producing a hollow body comprising the features of claim 38. Advantageous embodiments of the invention arise from the dependent claims of the subsequent description and figures.

According to an embodiment of the invention, a fibre-reinforced hollow body is proposed for channelling media, in particular chemically and/or mechanically aggressive media, for example, of the chemical industry and/or the process industry, in particular also of phosphorus plants, having a base body comprising a material containing fibres or consisting of a material containing fibres, and having a protective layer for protecting the hollow body, in particular the base body, against chemical and/or mechanical attacks. Furthermore, the protective layer is formed from a fibre-free material or a substantially fibre-free material.

Signs of wear and defects which result from fibres coming loose from the protective layer, for example, owing to chemically and/or mechanically aggressive media attacking the protective layer, for example, abrasive media, are prevented by the protective layer of such a hollow body. Such signs of wear and defects are at least counteracted. This is because, according to the invention, the protective layer is made without fibres or at least contains only a negligibly small amount of fibres. Even if these fibres were broken off from the protective layer, possible maintenance intervals of systems in which the hollow body is used would be not at all or only unsubstantially affected by same.

For example, the fibre-free material is a polymer, in particular, a resin or a resin composition. In this way, the protective layer has sufficient resistance at least to chemically aggressive media.

According to an embodiment of the invention, the protective layer contains or consists of at least one polymer and at least one fibre-free filler. In this way, the protective layer, on the one hand, achieves the desired and necessary resistance to chemical and/or mechanical attacks of the media impacting on the protective layer or flowing along the protective layer. Furthermore, it is ensured that volume shrinkage largely does not occur or at least occurs only to a small extent during manufacture of the protective layer. This effect on the volume shrinkage is brought about by the fibre-free filler.

For example, the protective layer has a composite material or is formed from such a composite material, the matrix of which contains or consists of at least one polymer, in which at least one fibre-free filler is embedded. The polymer can be the polymer described above. The fibre-free filler can be the filler described above.

It is recommended that the at least one polymer contain an epoxy resin, a preferably unsaturated polyester resin or a vinyl ester resin. The protective layer has a relatively high chlorine resistance because of the unsaturated polyester resin or the vinyl ester resin. The protective layer has a relatively high resistance to basic media because of the epoxy resin. In the case of chlorine-containing media attacking the protective layer, in particular media having a relatively high chlorine content, the at least one polymer should be an unsaturated polyester resin or a vinyl ester resin. In the case of an alkaline stress on the protective layer, the at least one polymer should be an epoxy resin.

For example, epoxy resin based on at least one bisphenol, epoxy resin based on at least one novolac or aliphatic epoxy resin is used. The polyester resin can be an unsaturated polyester resin, for example, based on HET acid and/or based on neopentyl glycol. The vinyl ester resin is, for example, a resin formed on the basis of at least one bisphenol A and/or on the basis of at least one novolac.

It is further recommended that the fibre-free filler consist of particles, in particular a plurality of particles, or comprise particles, in particular a plurality of particles. In this way, the effect on the mechanical material properties of the protective layer is as highly targeted as possible in that, for example, more or less particles and/or particles made of a material having a hardness which is higher or less high are used. For example, the filler used in the protective layer can be a powder.

It has been shown that instead of fibres, the use of particles of another kind can achieve the desired material properties of the protective layer and likewise the desired benefits when producing the protective layer, wherein the protective layer comprising such particles is sufficiently resistant to chemical attacks and/or to mechanical, in particular abrasive, attacks, and premature dissolution and release of particles largely does not occur or does not occur at all. It has also been shown that using such particles, the risk of pipes, screens, filters or other components of systems in which the hollow body is used being blocked is significantly reduced with respect to the dissolution and release of particles. In addition, volume shrinkage of the polymer can be reduced to the desired degree when producing the protective layer by means of particles.

By means of the fibre-free filler, the mechanical, chemical and/or electrical properties of the protective layer or of the fibre-free material can be influenced in a targeted manner in that depending on the material property sought, the proportion of filler in the total mass of the protective layer, the proportion of particles in the total mass of the protective layer, the size of the particles used and the material of the particles is varied. The processing properties of the fibre-free material forming the protective layer can be influenced.

It has been found that the material properties of the protective layer are positively influenced if particles comprising an equivalent diameter of about 2 micrometres to about 7 millimetres are used, wherein in each case particles which have substantially the same particle size or only relatively minor differences in the particle size should be used. In principle, distribution of the particle sizes over a broader range is possible.

The equivalent diameter is to be understood as that usually stated for the size of a particle in the particle size determination. The equivalent diameter is, in particular, a measure for the size of an irregularly shaped particle, such as a grain of sand. The equivalent diameter is calculated by comparing a property of the irregular particle with a property of the regularly shaped particle.

It has been shown, for example, that a sufficient resistance of the protective layer to chemical attacks is achieved if, according to an embodiment of the invention, at least some of the particles have an equivalent diameter of about 2 micrometres to about 500 micrometres, in particular 10 micrometres to 200 micrometres.

It has been found that there is a particularly high chemical resistance of the protective layer if at least some of the particles have an equivalent diameter of 63 micrometres to 90 micrometres.

It has been shown that a sufficient resistance of the protective layer to mechanical attacks, in particular abrasive attacks, is achieved if, according to an embodiment of the invention, at least some of the particles have an equivalent diameter of about 0.2 millimetres to about 6.3 millimetres, in particular 0.4 millimetres to 4 millimetres, for example about 4.0 millimetres.

It has been found that there is a particularly high mechanical resistance of the protective layer if at least some of the particles have an equivalent diameter of 0.63 micrometres to 2 micrometres, for example, about 2.0 millimetres.

It is recommended that the filler be inert, for example, in respect of the medium which comes into contact with the protective layer. In this way, it is ensured that possible chemical reactions of the filler with the medium largely do not occur or do not occur at all. In this way, possible weakening of the protective layer because of such reactions is effectively counteracted. The medium itself is also prevented from changing in an undesired manner in respect of the chemical properties of same as a result of possible reactions.

According to an embodiment of the invention, the filler is or contains a ceramic, in particular, the particles consist of ceramic or contain ceramic. In particular, the ceramic is an industrial ceramic. Same are to be understood, in particular, as ceramic materials which are optimised for industrial applications in respect of the properties of same, and differ as a result from decoratively used ceramics, tiles or sanitary objects and the suchlike, for example, in terms of purity and the more narrowly tolerated grain sizes in the source materials of same.

By using ceramic, the properties thereof which are relevant with respect to the chemical resistance and/or mechanical resistance of the protective layer are relied upon. The ceramic has a high heat resistance. The ceramic also has a high abrasion and wear resistance. In addition, ceramic is corrosion-resistant to many acids and alkalis. The ceramic also has mechanical strength.

It has been found that the protective layer has a high chemical resistance if, according to an embodiment of the invention, the filler is aluminium oxide or contains aluminium oxide, in particular at least some of the particles are formed from aluminium oxide or comprise aluminium oxide. In addition, it has been found that the filler has a high mechanical resistance if, according to another embodiment of the invention, the filler is a silicon carbide or contains a silicon carbide. In principle, the filler can contain aluminium oxide and silicon carbide.

In addition or alternatively, the filler can be or contain aluminium titanate, barium titanate, beryllium oxide, zirconium (IV) oxide, titanium (IV) oxide or another oxidic ceramic. The filler can also be or contain aluminium nitride, boron carbide, boron nitride, silicon nitride, tungsten carbide or another non-oxidic ceramic.

It has been found that the material properties of the protective layer are positively influenced if the filler comprising a proportion of the total mass of the protective layer is in a range from about 5% to about 95%.

It has been shown, for example, that a sufficient resistance of the protective layer to chemical attacks is achieved if, according to an embodiment of the invention, the filler has a proportion of the total mass of the protective layer of about 5 percent to about 60 percent, in particular 20 percent to 40 percent.

It has been shown that there is a particularly high chemical resistance of the protective layer to chemical attacks if, according to an embodiment of the invention, the filler has a proportion of the total mass of the protective layer of about 30 percent.

It has been shown that a sufficient mechanical resistance of the protective layer is achieved if, according to an embodiment of the invention, the filler has a proportion of the total mass of the protective layer of about 60 percent to about 95 percent, in particular 80 percent to 90 percent.

A particularly high mechanical resistance was achieved if, according to an embodiment of the invention, the filler has a proportion of the total mass of the protective layer of about 85 percent.

Furthermore it has been found that the hollow body has a sufficient service life in use, for example, by systems of the chemical industry and/or of the process industry, if the protective layer has a thickness in the range from about 0.3 millimetres to about 40 millimetres, in particular from about 0.5 millimetres to about 40 millimetres. In particular, the thickness of the protective layer should be substantially consistent. In principle, it is also possible to form the protective layer with regions of different thickness with respect to each other or with a varied thickness profile.

It has been shown that the protective layer has a sufficient service life against chemical attacks if, according to an embodiment of the invention, the protective layer has a thickness of about 0.3 millimetres to about 10 millimetres, in particular from 0.5 millimetres to 10 millimetres, in particular 3 millimetres to 8 millimetres.

It has been found that the protective layer has a particularly high service life in respect of the chemical resistance if, according to an embodiment of the invention, the protective layer has a thickness of about 6 millimetres.

It has further been shown that the protective layer has a sufficient service life in respect of mechanical attacks if, according to an embodiment of the invention, the protective layer has a thickness of about 5 millimetres to about 40 millimetres, in particular from 10 millimetres to 30 millimetres.

It has been found that the protective layer has a particularly high service life in respect of the mechanical resistance if, according to an embodiment of the invention, the protective layer has a thickness of about 25 millimetres.

According to another embodiment of the invention, the fibre-containing material of the base body is or contains at least one polymer. For example, the base body is formed from plastic, for example, from long-fibre-reinforced plastic.

The material of the base body can be a composite material, the matrix of which is formed by the at least one polymer or which contains the at least one polymer in which the fibres are embedded. In particular, the fibres of the base body are at least partially formed as reinforcing fibres. The fibres can be at least partially long fibres.

It has been shown that by using a material of this kind, the base body has sufficient component stability and component strength in order to prevent premature component failure when used in a system, for example, in a chemical plant.

The at least one polymer can be or contain an epoxy resin, a preferably unsaturated polyester resin or a vinyl ester resin. The base body has a relatively high chlorine resistance because of the unsaturated polyester resin or the vinyl ester resin. The base body has a relatively high resistance to basic media because of the epoxy resin.

The unsaturated polyester resin and/or vinyl ester resin also provide advantages during processing. The gelling time can be set more flexibly than, for example, compared with epoxy resin. Because of the epoxy resin, better mechanical properties of the base body are again achieved in comparison with the unsaturated polyester resin or vinyl ester resin.

For example, epoxy resin based on at least one bisphenol, epoxy resin based on at least one novolac or aliphatic epoxy resin is used. The polyester resin can be an unsaturated polyester resin, for example, based on HET acid and/or based on neopentyl glycol. The vinyl ester resin is, for example, a resin formed on the basis of at least one bisphenol A and/or on the basis of at least one novolac.

According to another embodiment of the invention, the fibres of the base body form at least one textile hose and/or at least one textile winding layer. As a result, an effective reinforcing structure is formed by means of the fibres, said reinforcing structure guaranteeing the strength and stability of the base body. For example, at least some of the fibres of the base body are a component of a mat, a woven fabric, a scrim, a meshed fabric, a knitted fabric or a roving.

Additionally or alternatively, the fibres of the base body can be at least partially glass fibres, particularly, fibres made of E-glass, or chemical-resistant fibres made of C-glass, E-glass, E-CR glass or AR-glass, or fibres made of boron-free glass.

It has been shown that sufficient stability of the base body is achieved if, according to an embodiment of the invention, the fibres of the base body have a proportion of the total mass thereof of 30 percent to 70 percent, in particular 38 percent to 60 percent.

There is particularly good component strength for a wide range of applications of the hollow body if, according to another embodiment of the invention, the fibres have a proportion of the total mass of the base body of about 50 percent.

In order to sufficiently guarantee the requirements for component strength of the hollow body over a predefined life cycle, it is recommended that the base body have a wall thickness of about 2 millimetres to about 40 millimetres, in particular, 3 millimetres to 20 millimetres. In particular, the wall thickness should be substantially consistent. In principle, it is also possible to form the base body with regions of different thickness with respect to each other or with a varied thickness profile.

According to another embodiment of the invention, the protective layer is an inner layer. The base body can then have a weather-resistant outer layer. In this way, the protective layer forms protection against mechanical and/or chemical attacks of a or the medium channelled through the hollow body. The base body is protected against environmental and weather effects by the outer layer. For example, the outer layer also has UV protection.

In principle, the protective layer can also form or be an outer layer of the base body.

In order to give the weather-resistant outer layer sufficient stability, according to another embodiment of the invention, the weather-resistant outer layer contains at least one nonwoven fabric. A reinforcing structure is formed by the nonwoven fabric, in particular the fibres of the nonwoven fabric.

The weather-resistant outer layer can also be formed from a polymer or contain a polymer. For example, the at least one polymer is an epoxy resin, a polyester resin or a vinyl ester resin.

For example, the nonwoven fabric or the fibres of the nonwoven fabric is/are at least partially glass fibres or synthetic fibres.

It has been found that the weather-resistant outer layer has an optimum effect on the hollow body if, according to an embodiment of the invention, the outer layer has a wall thickness of 50 micrometres to 200 micrometres or exceeds a wall thickness of 50 micrometres. In particular, the wall thickness should be substantially consistent. In principle, it is also possible to form the outer layer with regions of different thickness with respect to each other or with a varied thickness profile.

Provided the technical requirements for the hollow body require electrical conductivity or electrical dissipation capability, the material of the protective layer, the material of the base body and/or the material of the outer layer can be electrically conductive or electrically dissipative

According to requirements, the material of the protective layer, the material of the base body and/or the material of the outer layer can be highly flame-retardant.

According to requirements, the material of the protective layer and/or the material of the base body can contain or consist of the same polymer. As a result, the hollow body can be produced cost-effectively.

In a simple manner, the hollow body can be achieved industrially if the protective layer is applied to the base body, wherein at least one intermediate layer can also lie between the base body and the protective layer

The base body can further be formed by at least one support layer. For example, the hollow body can be built using three layers, of which one layer is the support layer forming the base body, the other layer is the protective layer described above and the other layer in turn is the outer layer described above.

The hollow body can have any shape or form any moulded part which is used to channel a medium. For example, hollow body is a longitudinal hollow body, in particular a pipe element. The hollow body can also be a fitting, a reducer, a sleeve, a nozzle, a flange or an elbow.

Furthermore, the invention relates to a chemical composition for forming a protective layer of a hollow body, in particular of a plastic hollow body, for channelling media, in particular chemically and/or mechanically aggressive media, for example, of the chemical industry and/or the process industry, said protective layer protecting against chemical and/or mechanical attacks. For example, the protective layer is an inner layer of a hollow space of the hollow body, which is used for channelling such media. The hollow body can be the hollow body described above or a hollow body of the kind described above.

The chemical composition consists of a fibre-free material or substantially fibre-free material. In this way, the protective layer produced as a result has the advantage that signs of wear which result from fibres coming loose from the protective layer, for example, owing to chemically and/or mechanically aggressive media attacking the protective layer, are prevented. This is because, according to the invention, the protective layer is made without fibres or at least contains only a negligibly small amount of fibres. Even if these fibres were broken off from the protective layer, possible maintenance intervals of systems in which the hollow body is used would be not at all or only unsubstantially affected by same.

According to an embodiment of the invention, the material is a composite material and contains or consists of at least one polymer, in particular, at least one resin, and at least one fibre-free filler.

The material, in particular the composite material, is processed well if the filler is a powder and/or the polymer is in a flowable form. For example, the filler is a ceramic powder.

For example, the chemical composition, in addition to the resin and the filler, also contains at least one accelerator and at least one curing agent, in particular if the at least one polymer is or contains an unsaturated polyester resin or a vinyl ester resin. In particular, if the at least one polymer contains an epoxy resin, the chemical composition, in addition to the resin and the filler, also contains at least one curing agent, although preferably no accelerator.

Furthermore, the invention also relates to a method for producing the hollow body described above or a hollow body of the kind described above. The method is characterised in that to form the protective layer a chemical composition consisting of a fibre-free material or a substantially fibre-free material, for example, the chemical composition described above, is applied to a core element which shapes at least one hollow space of the hollow body and then a material for building up a support layer which forms the base body is applied to said core element. In this way, a hollow body comprising a protective layer which is fibre-free or substantially fibre-free can be achieved in a simple manner in terms of production.

By means of the invention, a hollow body, for example in the form of a pipe element, which has a high chemical resistance to chemical attacks of flowing media can be achieved. As a result, higher operational reliability and longer operating time of the system in which the hollow body is used are guaranteed.

The invention can also provide a hollow body which has a protective layer that permanently does not release any fibres during a chemical and/or mechanical attack of the medium or releases only negligibly few fibres so that blocking of the lines and clogging, for instance, of screens and/or filters are prevented.

Overall, by means of the hollow body, the amount of operational downtime and the duration of the downtime of systems in which the hollow body is used are reduced since in the case of channelled aggressive, in particular, highly aggressive media, no premature component failure occurs and increased cleaning costs owing to the cleaning of blocked lines and clogged screens are avoided.

In addition, the hollow body is suitable both for channelling acidic media and for channelling basic media. For channelling acidic media, the protective layer can be formed by means of an unsaturated polyester resin or a vinyl ester resin which forms a matrix material for the composite material. In the case of channelled basic media, epoxy resin can be used as a matrix material.

Further aims, advantages, features and applications of the present invention emerge from the following description of a plurality of exemplary embodiments on the basis of the drawing. All features described and/or illustrated form the subject matter of the present invention per se or in any meaningful combination, independent of their summary in the claims or their dependency reference.

The only FIGURE (FIG.) shows a possible embodiment of a hollow body 10 for channelling media by way of the example of a cross-sectional representation of a pipe element.

The hollow body 10 is suitable for channelling brines or other chlorine-containing liquids. The hollow body 10 can also be used as a catholyte line or anolyte line in chlor-alkali electrolysis. In principle, the hollow body 10 is suitable for channelling all media, such as liquids and/or gases, which are mechanically and/chemically aggressive.

The hollow body 10 has a protective layer 40 which is used for protecting the hollow body 10 against chemical and/or mechanical attacks of the medium coming in contact with the hollow body 10. The protective layer 40 is formed from a substantially fibre-free material. This prevents typical erosion of the protective layer 40 caused by corrosion over the service life of the hollow body 10 from being able to occur to the extent that any fibres contained in the protective layer 40 are released, which leads to blocking of the hollow body and/or clogging of any screen elements, filters or other components of the system. Possible release of fibres is prevented in that the protective layer is formed from the substantially fibre-free material.

Preferably, the protective layer 40 forms the inner layer 50 of the hollow body 10, which surrounds a hollow space 70 of the hollow body 10. The hollow body 10 is protected by means of the protective layer 40 against possible mechanical and/or chemical attacks of the medium channelled through the hollow body 10.

The hollow body 10 comprises a base body 20, which is substantially shaping for the hollow body 10 and preferably consists of a fibre-reinforced plastic and contains a fibre-reinforced plastic. For example, the base body 20 is formed by a support layer 30 comprising the fibre-reinforced material. The protective layer 40 can be applied directly to the wall or the support layer 30 of the base body 20 or an intermediate layer (not illustrated in the FIGURE) can be arranged therebetween, between the protective layer 40 and the base body 20 of the support layer 30.

Preferably, the hollow body 10 also has an outer layer 60, which is advantageously weather-resistant, in particular UV-resistant.

Preferably, the protective layer 40 comprises or is made of a polymer, for example, a resin, and at least one fibre-free filler. The fibre-free filler can also consist of ceramic particles or contain ceramic particles.

Preferably, the support layer 30 is formed by at least one polymer, for example, at least one resin, and at least one fibre-based reinforcing structure, such as a cut glass mat. The outer layer 60 can also be formed by a polymer, such as a resin, or such a material. In addition, a nonwoven fabric or similar fibre-reinforced structure can be inserted or embedded in the outer layer 60 for reinforcement.

Such a hollow body 10 formed as a pipe element can be produced in nominal diameters DN 25 to DN 800.

The following table gives, for example, four prototypes of the hollow body 10 in the form of a pipe element, for example, in the form of a flanged pipe, wherein, for example, the diameter DN 200 is used. In the case of the four hollow bodies 10 listed in the table, which are designated prototype A, prototype B, prototype C and prototype D, the protective layer 40, the support layer 30 and the outer layer 60 are made from the same polymer.

In the case of prototype A, the polymer is an unsaturated polyester resin based on at least one HET acid and neopentyl glycol. In the case of prototype B, the at least one polymer is a vinyl ester resin based on at least one novolac; in the case of prototype C and in the case of prototype D the at least one polymer is an epoxy resin based on a bisphenol A with cycloaliphatic polyamide hardener.

The thickness of the protective layer 40, the mass proportion of the filler in the protective layer 40 and the filler used are shown as such in the table. Furthermore, in respect to the support layer 30, the thickness, the material used as fibre reinforcement and the proportion of the support layer 30 in the overall mass are shown. In addition, the table shows the thickness of the outer layer 60 and information concerning a nonwoven fabric inserted in the outer layer 60.

At least one cut E-glass mat and at least one E-glass woven fabric, which are arranged alternately with respect to each other, are used for fibre reinforcement of the support layer 30. Preferably, the cut E-glass mat has a mass per unit area, hereinafter referred to as the area weight, of about 450 g/m² and the E-glass woven fabric has an area weight of 800 g/m². The nonwoven fabric used in the outer layer 60 is formed from a C-glass comprising an area weight of about 33 g/m² in the case of prototypes A, B and D. Prototype C has a polyester nonwoven fabric, which has an area weight of about 26 g/m².

TABLE
Prototypes as pipe element with diameter DN 200

| | Protective layer | | | Support layer | | | Outer layer | |
|---|---|---|---|---|---|---|---|---|
| Proto- | Thick- | | | Thick- | Fibre | | Thick- | Nonwoven |
| type | ness | Filler | Proportion | ness | reinforcement | Proportion | ness | fabric |
| A | 3.5 mm | Aluminium | 30% | 3 mm | Cut E-glass mat | 40% | 0.3 mm | C-glass |
| | | oxide | | | E-glass woven | | | |
| | | | | | fabric | | | |
| B | 3.5 mm | Aluminium | 30% | 3 mm | Cut E-glass mat | 40% | 0.3 mm | C-glass |
| | | oxide | | | E-glass woven | | | |
| | | | | | fabric | | | |
| C | 3.5 mm | Aluminium | 30% | 3 mm | Cut E-glass mat | 40% | 0.3 mm | Polyester |
| | | oxide | | | E-glass woven | | | |
| | | | | | fabric | | | |
| D | 25 mm | Silicon | 85% | 5 mm | Cut E-glass mat | 40% | 0.3 mm | C-glass |
| | | carbide | | | E-glass woven | | | |
| | | | | | fabric | | | |

A possible procedure for producing a hollow body, as shown in the only FIGURE, can be described as follows:

A flowable chemical composition is applied to a core element shaping the hollow space 70 of the hollow body 10. The flowable chemical composition contains the at least one polymer, the fibre-free filler, the curing agent and, optionally, the accelerator. For example, the flowable chemical composition is applied to the core element in that the core element is set in rotation, and by means of painting, spraying, pouring or the suchlike the chemical composition is applied to the core element so that a layer forms, which forms the protective layer 40 after setting and curing.

Depending on the desired layer thickness, the application occurs in a plurality of partial steps up to a predefined final thickness of the protective layer 40.

A cut glass mat is now applied to the not yet gelled layer of the already applied chemical composition and on this at least one polymer, for example, a resin composition made of unsaturated polyester resin, accelerator and curing agent is applied. A layer of cut glass mats is thus formed, which forms the first layer of the support layer 30.

After gelling of the protective layer 40 and of the first layer of the support layer 30, lamination of the support layer 30 takes place by means of conventional methods, for example, by means of manual lamination with the resin composition already used for forming the first layer of the support layer 30 and textile glass fibre products, for example, in the form of cut glass mats and glass woven fabric. This building up of further layers of the support layer 30 takes place until the desired thickness of the support layer 30 is achieved.

In order to form the outer layer 60, preferably styrene-soluble glass fibre nonwoven fabric is then applied to the surface of the not yet gelled surface of the support layer 30, and the glass nonwoven fabric is impregnated with a resin composition, for example, made of unsaturated polyester resin, accelerator, paraffin wax, UV inhibitor and curing agent, and the outer layer 60 is then sealed toward the outside as a result.

After hardening and, optionally, a heat treatment of the materials, the hollow body 10 is completed.

### REFERENCE LIST

10 Hollow body
20 Base body
30 Support layer
40 Protective layer
50 Inner layer
60 Outer layer
70 Hollow space

1. A fibre-reinforced hollow body (10) for channeling media, in particular, chemically and/or mechanically aggressive media, for example, of the chemical industry and/or the process industry, having a base body (20), comprising a material containing fibres, and having a protective layer (40) for protecting the hollow body (10) against chemical and/or mechanical attacks, wherein the protective layer (40) is formed from a fibre-free material or a substantially fibre-free material.

2. A hollow body according to claim 1, characterized in that the protective layer (40) contains or consists of at least one polymer and at least one fibre-free filler.

3. A hollow body according to claim 1 characterized in that the protective layer (40) contains or consists of at least one resin and at least one fibre-free filler.

4. A hollow body according to claim 1 characterized in that the protective layer (40) has a composite material or is formed from a composite material, wherein the matrix of the composite material contains at least one polymer or consists thereof, in which at least one fibre-free filler is embedded.

5. A hollow body according to claim 2 characterized in that the at least one polymer is or contains an epoxy resin.

6. A hollow body according to claim 5 characterized in that the epoxy resin is an epoxy resin based on at least one bisphenol, an epoxy resin based on at least one novolac or an aliphatic epoxy resin.

7. A hollow body according to claim 2 characterized in that the at least one polymer is or contains a polyester resin.

8. A hollow body according to claim 7 characterized in that the unsaturated polyester resin is a polyester resin based on HET acid and/or based on neopentyl glycol.

9. A hollow body according to claim 2 characterized in that the at least one polymer is or contains a vinyl ester resin.

10. A hollow body according to claim 9 characterized in that the vinyl ester resin is a vinyl ester resin based on at least one bisphenol A and/or based on at least one novolac.

11. A hollow body according to claim 2 characterized in that the fibre-free filler consists of particles or comprises particles.

12. A hollow body according to claim 11 characterized in that the particles have an equivalent diameter of about 2 micrometres to about 7 millimetres.

13. A hollow body according to claim 11 characterized in that some of the particles have an equivalent diameter of about 2 micrometres to about 500 millimetres.

14. A hollow body according to claim 11 characterized in that at least some of the particles have an equivalent diameter of about 0.2 millimetres to about 6.3 millimetres.

15. A hollow body according to claim 2 characterized in that the filler is or contains a ceramic.

16. A hollow body according to claim 2 characterized in that the filler is aluminium oxide or silicon carbide or contains aluminium oxide and/or silicon carbide.

17. A hollow body according claim 2 characterized in that the filler is or contains aluminium titanate, barium titanate, beryllium oxide, zirconium (IV) oxide, titanium (IV) oxide or another oxidic ceramic.

18. A hollow body according to claim 2 characterized in that the filler has a proportion of the overall mass of the protective layer (40) of about 5 percent to about 95 percent.

19. A hollow body according to claim 2 characterized in that the filler has a proportion of the overall mass of the protective layer (40) of about 5 percent to about 60 percent.

20. A hollow body according claim 2 characterized in that the filler has a proportion of the overall mass of the protective layer (40) of about 60 percent to about 95 percent.

21. A hollow body according to claim 1 characterized in that the protective layer (40) has thickness of 0.3 millimetres to 40 millimetres.

22. A hollow body according to claim 1 characterized in that the protective layer (40) has thickness of 0.3 millimetres to 10 millimetres.

23. A hollow body according claim 1 characterized in that the protective layer (40) has thickness of 5 millimetres to 40 millimetres.

24. A hollow body according to claim 1 characterized in that the fibre-containing material of the base body (20) is or contains at least one polymer.

25. A hollow body according to claim 24 characterized in that the fibre-containing material of the base body (20) is a composite material, the matrix of which is formed by the at least one polymer or which contains the at least one polymer in which the fibres are embedded.

26. A hollow body according to claim 24 characterized in that the at least one polymer is an epoxy resin.

27. A hollow body according to claim 1 characterized in that the fibres of the base body (20) form at least one textile hose and/or at least one textile winding layer.

28. A hollow body according to claim 1 characterized in that the fibres of the base body (20) are at least partially glass fibres.

29. A hollow body according to claim 1 characterized in that the fibres of the base body (20) have a proportion of the overall mass thereof of 30 percent to 70 percent.

30. A hollow body according to claim 1 characterized in that the base body (20) has wall thickness of about 2 millimetres to about 40 millimetres.

31. A hollow body according claim 1 characterized in that the protective layer (40) has an inner layer (50) and the base body (20) has a weather-resistant outer layer (60).

32. A hollow body according to claim 31 characterized in that the outer layer (60) has a wall thickness of 50 micrometres to 200 micrometres.

33. A hollow body according to claim 1 characterized in that the hollow body (10) is a pipe element, a fitting, a reducer, a sleeve, a nozzle, a flange or an elbow.

34. A chemical composition for forming a protective layer (40) of a hollow body (10), said protective layer protecting against chemical and/or mechanical attacks, and said hollow body being for channeling media, in particular chemically and/or mechanically aggressive media, for example, of the chemical industry and/or the process industry, in particular according to any one of the preceding claims, consisting of a fibre-free material or a substantially fibre-free material.

35. A composition according to claim 34 characterized in that the material is a composite material and contains or consists of at least one polymer and at least one fibre-free filler.

36. A composition according to claim 34 characterized in that the material is a composite material and contains or consists of at least one resin and at least one fibre-free filler.

37. A composition according to claim 35 characterized in that the filler is pulverulent and the polymer is in a flowable form.

38. A method for producing a hollow body (10) according to claim 1, in which in order to form the protective layer (40) a chemical composition according to claim 34, consisting of a fibre-free material or a substantially fibre-free material, is applied to a core element which shapes at least one hollow space (70) of the hollow body (10), and then a material for building up a support layer (30) which forms the base body (20) is applied to said core element.

39. A fibre-reinforced hollow body (10) for channeling media, in particular, chemically and/or mechanically aggressive media, for example, of the chemical industry and/or the process industry, having a base body (20), comprising a material containing fibres, and having a protective layer (40) formed from a fibre-free material or a substantially fibre-free material for protecting the hollow body (10) against chemical and/or mechanical attacks, wherein the protective layer (40) contains or consists of at least one polymer and at least one fibre-free filler, characterized in that the fibre-free filler consists of particles or comprises particles, which contain or consist of ceramic.
